(19) United States
(12) Patent Application Publication
(10) Pub. No.: US 2024/0377676 A1
(43) Pub. Date: Nov. 14, 2024

(54) DISPLAY DEVICE

(71) Applicant: Japan Display Inc., Tokyo (JP)

(72) Inventors: Yoshikatsu IMAZEKI, Tokyo (JP); Yoichi KAMIJO, Tokyo (JP); Yoshifumi KAMEI, Tokyo (JP); Koichi MIYASAKA, Tokyo (JP); Shuichi OSAWA, Tokyo (JP)

(21) Appl. No.: 18/656,871

(22) Filed: May 7, 2024

(30) Foreign Application Priority Data
May 10, 2023 (JP) 2023-077908

(51) Int. Cl. G02F 1/1335

(52) U.S. Cl. CPC G02F 1/133514; G02F 2201/50; G02F 2202/28

(57) ABSTRACT

A display device includes a display panel having a display surface having a display region where an image is displayed and an opposite surface on an opposite side of the display surface, a color separation element placed on the opposite surface side of the display panel and configured to disperse light from a light source and to emit, to the display panel, a plurality of rays of separated light with wavelengths different from each other, and an adhesive portion bonding the display panel to the color separation element. The adhesive portion forms a space portion overlapping the display region in plan view of the display surface and also has a plurality of side walls forming a communicating passage through which the space portion communicates with an atmosphere, and the communicating passage has a labyrinth structure.

### CROSS-REFERENCE TO RELATED APPLICATION

This application claims the benefit of priority from Japanese Patent Application No. 2023-077908 filed on May 10, 2023, the entire contents of which are incorporated herein by reference.

### BACKGROUND

### 1. Technical Field

The present disclosure relates to a display device.

### 2. Description of the Related Art

The display device in Japanese Patent Application Laid-open Publication No. H10-319217 (JP-A-H10-319217) includes a liquid crystal display panel having pixels, a color separation element, and a surface light source device that irradiates the color separation element with light. The color separation element separates light from the surface light source device into beams of light in colors different from each other and focuses the beams of light on the pixels of the display panel.

In the display device in JP-A-H10-319217, the display panel and the color separation element desirably have an air layer therebetween so that the pixels are irradiated with the light from the color separation element. The color separation element is bonded to the display panel with an adhesive, for example. The adhesive is applied around a display region of the display panel where images are displayed.

The adhesive is desirably not applied continuously around the entire perimeter of the display region of the display panel, but applied with a gap. Without the gap, air surrounded by the adhesive between the display panel and the color separation element is compressed, and the display panel and the color separation element may be deformed. Meanwhile, foreign matter may enter through the gap and reach the air layer. When foreign matter reaches the air layer, the luminance of an image displayed on the display panel may be decreased.

It is an object of the present disclosure to provide a display device that can suppress foreign matter's entry.

### SUMMARY

A display device according to the present disclosure includes a display panel having a display surface having a display region where an image is displayed and an opposite surface on an opposite side of the display surface, a color separation element placed on the opposite surface side of the display panel and configured to disperse light from a light source and to emit, to the display panel, a plurality of rays of separated light with wavelengths different from each other, and an adhesive portion bonding the display panel to the color separation element. The adhesive portion forms a space portion overlapping the display region in plan view of the display surface and also has a plurality of side walls forming a communicating passage through which the space portion communicates with an atmosphere, and the communicating passage has a labyrinth structure.

### BRIEF DESCRIPTION OF THE DRAWINGS

FIG. 1 is a plan view of a display device according to an embodiment of the present disclosure;

FIG. 2 is a sectional view of the display device taken along a line II-II in FIG. 1;

FIG. 3 is a view illustrating a circuit configuration of a display panel;

FIG. 4 is a sectional view of the display panel;

FIG. 5 is a sectional view of a color separation element;

FIG. 6 is an enlarged sectional view of the color separation element;

FIG. 7 is a plan view of the display device illustrating an adhesive portion viewed from the display panel side;

FIG. 8 is a view illustrating an adhesive portion of the display device according to a first modification of the embodiment of the present disclosure;

FIG. 9 is a view illustrating an adhesive portion of the display device according to a second modification of the embodiment of the present disclosure;

FIG. 10 is a view illustrating an adhesive portion of the display device according to a third modification of the embodiment of the present disclosure;

FIG. 11 is a view illustrating an adhesive portion of the display device according to a fourth modification of the embodiment of the present disclosure;

FIG. 12 is a partially enlarged sectional view of a communicating passage illustrating a first uneven region;

FIG. 13 is a view illustrating an adhesive portion of the display device according to a fifth modification of the embodiment of the present disclosure;

FIG. 14 is an enlarged plan view of the communicating passage illustrating second uneven regions; and

FIG. 15 is a sectional view of a display device taken along a line XV-XV illustrated in FIG. 14.

### DETAILED DESCRIPTION

Embodiments of the present disclosure will be described below with reference to the drawings. The present disclosure is not limited by what is described in the following embodiments. Components described below include those that can be easily assumed by a person skilled in the art and those that are substantially the same. Furthermore, the components described below can be combined as appropriate.

What is disclosed herein is merely an example, and any appropriate modification that would be easily conceived of by a person skilled in the art, while maintaining the purport of the present disclosure, is naturally included in the scope of the present disclosure. The drawings may schematically illustrate the width, thickness, shape, and the like of each part compared to the actual mode for the sake of clarity of explanation, but this is merely an example and does not limit the interpretation of the present disclosure. In the present specification and the drawings, elements similar to those described previously with respect to the drawings already mentioned are given the same reference signs and the detailed description thereof may be omitted as appropriate.

The X and Y directions illustrated in the drawings are orthogonal to each other and parallel to a main surface of a substrate included in a display device 1. The +X and −X sides in the X direction and the +Y and −Y sides in the Y direction correspond to the sides of the display device 1. The Z direction is orthogonal to the X and Y directions and corresponds to the thickness direction of the display device 1. The +Z side in the Z direction corresponds to the front surface side where an image is displayed in the display device 1, and the −Z side in the Z direction corresponds to the rear surface side of the display device 1. The X, Y, and Z directions are examples, and the present disclosure is not limited to these directions. In the present specification, “plan view” refers to viewing the display device 1 from the +Z side to the −Z side along the Z direction and corresponds to a plan view of a display surface 10a to be described below.

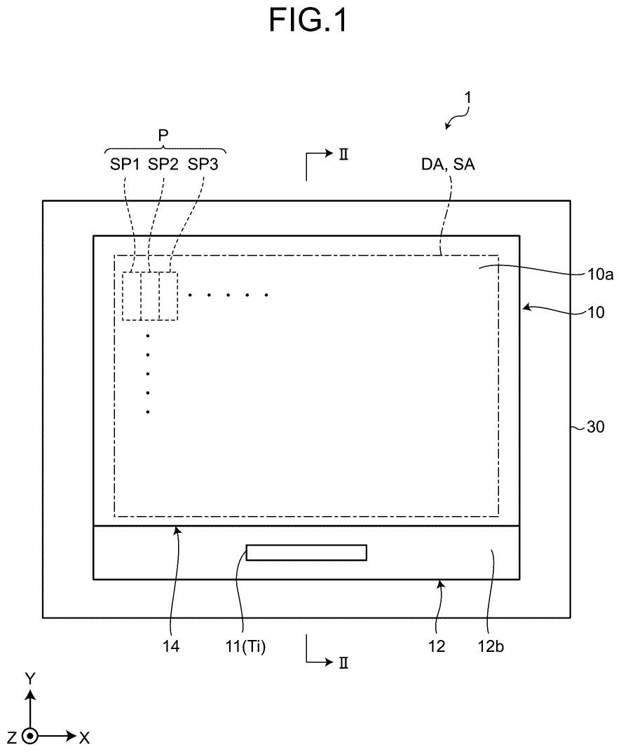

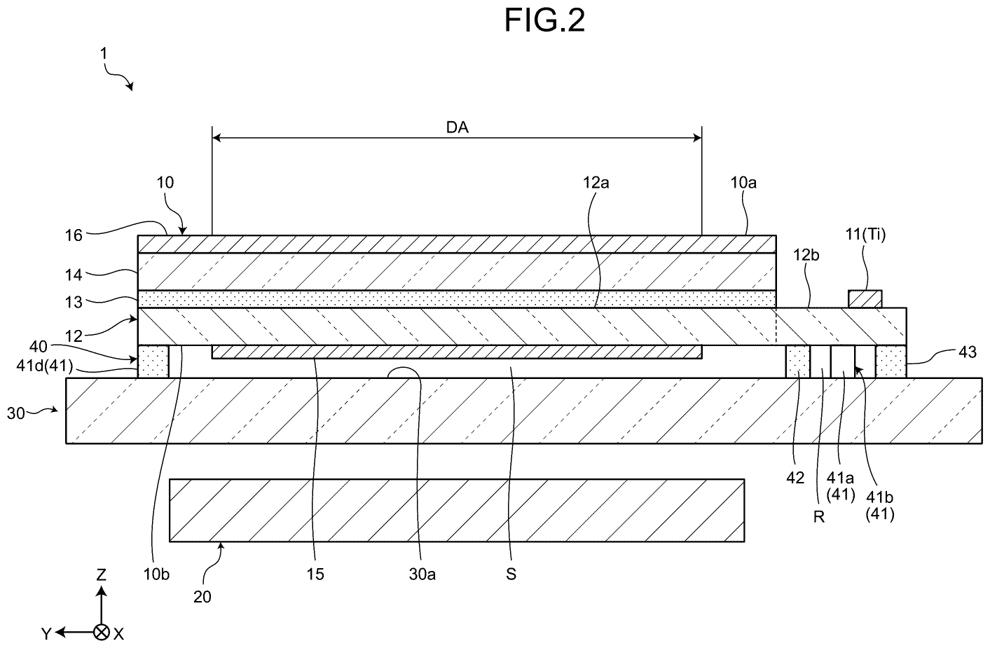

FIG. 1 is a plan view of the display device 1 according to an embodiment of the present disclosure. FIG. 2 is a sectional view of the display device 1 taken along a line II-II in FIG. 1. The display device 1 displays images on the basis of image signals output from an external device (not illustrated) that is electrically coupled through a flexible wiring board (not illustrated).

The display device 1 is applied, for example, to a head-up display. The head-up display projects an image onto a translucent object, such as a vehicle windshield, to allow a user to see a virtual image. The display device 1 includes a display panel 10, a light source device 20, a color separation element 30, and an adhesive portion 40. The light source device 20, the color separation element 30, and the display panel 10 are aligned in this order along the Z direction from the −Z side to the +Z side.

The display panel 10 is a transmissive liquid crystal display. The display panel 10 may be, for example, an organic electroluminescent (EL) display and an inorganic EL display. As illustrated in FIGS. 1 and 2, the display panel 10 has the display surface 10a having a display region DA where images are displayed and an opposite surface 10b on the opposite side of the display surface 10a. The display surface 10a corresponds to the front surface of the display panel 10. The opposite surface 10b corresponds to the rear surface of the display panel 10. As illustrated in FIG. 1, the display panel 10 includes a plurality of pixels P aligned in a matrix (row-column configuration) along the X and Y directions in the display region DA.

The pixels P each have a first sub-pixel SP1, a second sub-pixel SP2, and a third sub-pixel SP3. The first sub-pixel SP1 is a red sub-pixel. The second sub-pixel SP2 is a green sub-pixel. The third sub-pixel SP3 is a blue sub-pixel. The first sub-pixel SP1, the second sub-pixel SP2 and the third sub-pixel SP3 are aligned in this order along the X direction. The array of the first sub-pixel SP1, the second sub-pixel SP2 and the third sub-pixel SP3 is what is called a stripe array. Hereinafter, when the first sub-pixel SP1, the second sub-pixel SP2, and the third sub-pixel SP3 are described without distinction, they may simply be described as a “sub-pixel SP”. It is needless to say that the array of sub-pixels SP is not limited to a stripe array, and the colors of sub-pixels SP are not limited to the aforementioned colors.

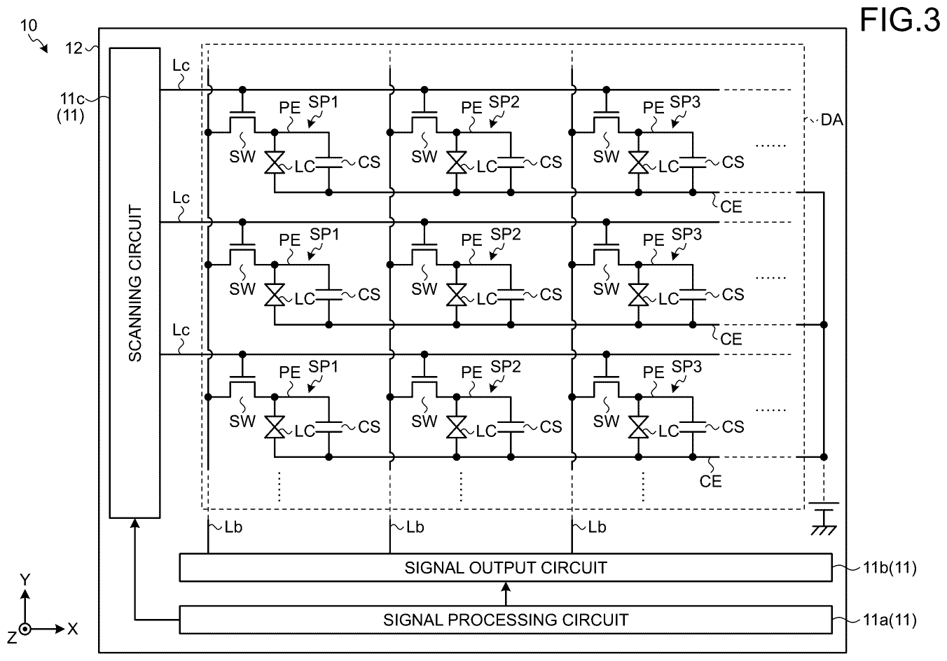

FIG. 3 is a view illustrating a circuit configuration of the display panel 10. The display panel 10 includes a drive circuit 11, as well as a switching element SW, a sub-pixel electrode PE, a common electrode CE, a liquid crystal capacitance LC, and a holding capacitance CS that are included in each of a plurality of the sub-pixels SP.

The drive circuit 11 drives the display panel 10. The drive circuit 11 includes a signal processing circuit 11a, a signal output circuit 11b, and a scanning circuit 11c.

The signal processing circuit 11a outputs sub-pixel signals indicating gradations of the sub-pixels SP to the signal output circuit 11b on the basis of image signals transmitted from the external device. The signal processing circuit 11a outputs clock signals to the signal output circuit 11b and the scanning circuit 11c to synchronize the operation of the signal output circuit 11b with that of the scanning circuit 11c.

The signal output circuit 11b outputs the sub-pixel signals to the sub-pixels SP. The signal output circuit 11b and the sub-pixels SP are electrically coupled through a plurality of signal lines Lb extending along the Y direction.

The scanning circuit 11c scans the sub-pixels SP in synchronization with the output of the sub-pixel signals by the signal output circuit 11b. The scanning circuit 11c and the sub-pixels SP are electrically coupled through a plurality of scanning lines Lc extending along the X direction.

A region demarcated by two signal lines Lb adjacent to each other in the X direction and two scanning lines Lc adjacent to each other in the Y direction in plan view corresponds to a sub-pixel SP.

The switching element SW includes a thin-film transistor (TFT), for example. In the switching element SW, a source electrode is electrically coupled to the signal line Lb, and a gate electrode is electrically coupled to the scanning line Lc.

The sub-pixel electrode PE is coupled to a drain electrode of the switching element SW. A plurality of the common electrodes CE are arranged corresponding to the scanning lines Lc. The sub-pixel electrode PE and the common electrode CE are translucent.

The liquid crystal capacitance LC is a capacitive component of a liquid crystal material in a liquid crystal layer 13, which will be described below, between the sub-pixel electrode PE and the common electrode CE. The holding capacitance CS is placed between an electrode with the same potential as the common electrode CE and an electrode with the same potential as the sub-pixel electrode PE.

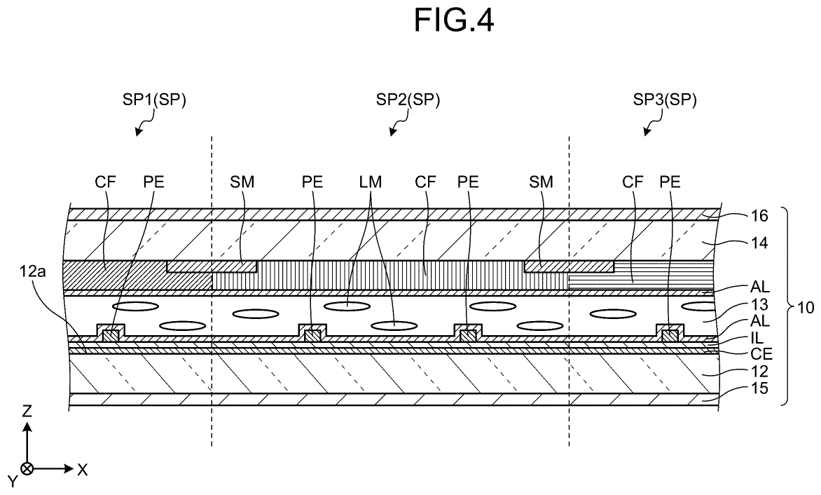

FIG. 4 is a sectional view of the display panel 10. The sub-pixel SP further includes a first substrate 12, the liquid crystal layer 13, and a second substrate 14. The first substrate 12, the liquid crystal layer 13, and the second substrate 14 are all translucent and are aligned in this order along the Z direction from the −Z side to the +Z side. The first substrate 12 and the second substrate 14 are rectangular in plan view.

The common electrode CE is placed on a main surface 12a on the +Z-side of the first substrate 12. An insulating layer IL is placed on the front surface of the common electrode CE, and the sub-pixel electrode PE and an orientation film AL are further placed.

The sub-pixel electrode PE is placed between the insulating layer IL and the orientation film AL. In this manner, the common electrode CE is placed on, and the sub-pixel electrode PE is placed above the first substrate 12. In other words, the display panel 10 is a horizontal electric field type liquid crystal display.

The second substrate 14 is located on the front surface side of the first substrate 12. A color filter CF and a light-shielding film SM are placed on, and an orientation film AL is placed under the rear surface of the second substrate 14. The light-shielding film SM and the color filter CF are placed between the second substrate 14 and the orientation film AL.

The color filter CF is rectangular in plan view and one color filter CF is placed for one sub-pixel SP. The color filter CF is translucent, and the peak of the spectrum of light to be transmitted is predetermined. The peak of the spectrum corresponds to the color of the color filter CF. The color of the color filter CF is the same as that of the sub-pixel SP. In other words, the red first sub-pixel SP1 has a red color filter CF, the green second sub-pixel SP2 has a green color filter CF, and the blue third sub-pixel SP3 has a blue color filter CF.

The light-shielding film SM is lightproof and overlaps in plan view the boundaries of the sub-pixels SP that are adjacent to each other in the X and Y directions. That is, the light-shielding film SM overlaps the signal line Lb and the scanning line Lc in plan view. In FIG. 4, the signal line Lb and the scanning line Lc are omitted. The signal lines Lb and the scanning lines Lc are placed on the main surface 12a of the first substrate 12.

The liquid crystal layer 13 includes a plurality of liquid crystal molecules LM. The liquid crystal layer 13 is present between the first substrate 12 and the second substrate 14 and overlaps the display region DA in plan view. Specifically, the liquid crystal layer 13 is present between two orientation films AL facing each other. The orientation of the liquid crystal molecules LM is regulated by the two orientation films AL facing each other.

As illustrated in FIGS. 2 and 4, the display panel 10 further includes a first polarizing plate 15 placed on the rear surface of the first substrate 12 and a second polarizing plate 16 placed on the front surface of the second substrate 14.

The first polarizing plate 15 has a transmission axis orthogonal to the Z direction. The second polarizing plate 16 has a transmission axis orthogonal to the transmission axis of the first polarizing plate 15 and the Z direction.

As illustrated in FIGS. 1 and 2, the first substrate 12 has an exposed portion 12b that is exposed from the second substrate 14 in plan view. The exposed portion 12b is on the −Y side of the second substrate 14 in plan view. It is needless to say that the position of the exposed portion 12b is not limited to the aforementioned position. For example, the exposed portion 12b may be on the +X side of the second substrate 14 in plan view, or on the −Y and +X sides of the second substrate 14 in plan view. An IC chip Ti including the drive circuit 11 is placed on the front surface of the exposed portion 12b. The front surface of the exposed portion 12b is part of the main surface 12a of the first substrate 12.

The drive circuit 11 outputs sub-pixel signals to the sub-pixels SP on the basis of image signals, thereby generating an electric field in the liquid crystal layer 13 and changing the orientation of the liquid crystal molecules LM. Thus, the light transmitted through the display panel 10 is modulated, to display an image.

As illustrated in FIG. 2, the light source device 20 is placed on the rear surface side of the display panel 10. The light source device 20 emits light (hereinafter described as emitted light) toward the display panel 10. The light source device 20 is, for example, a direct-lit backlight and has a plurality of light-emitting diodes (not illustrated).

As illustrated in FIGS. 1 and 2, the color separation element 30 is a rectangular plate in plan view. The color separation element 30 is larger than the display panel 10 in plan view. Specifically, the periphery of the color separation element 30 is located outside the periphery of the display panel 10 in plan view. Part of the color separation element 30 may be located outside the display panel 10 in plan view.

As illustrated in FIG. 2, the color separation element 30 is placed on the opposite surface 10b side of the display panel 10. Specifically, the color separation element 30 is placed between the display panel 10 and the light source device 20. The color separation element 30 is formed by silicon nitride being stacked, for example. The color separation element 30 may be formed by glass being cut. The color separation element 30 is translucent, and the emitted light from the light source device 20 enters the display panel 10 through the color separation element 30.

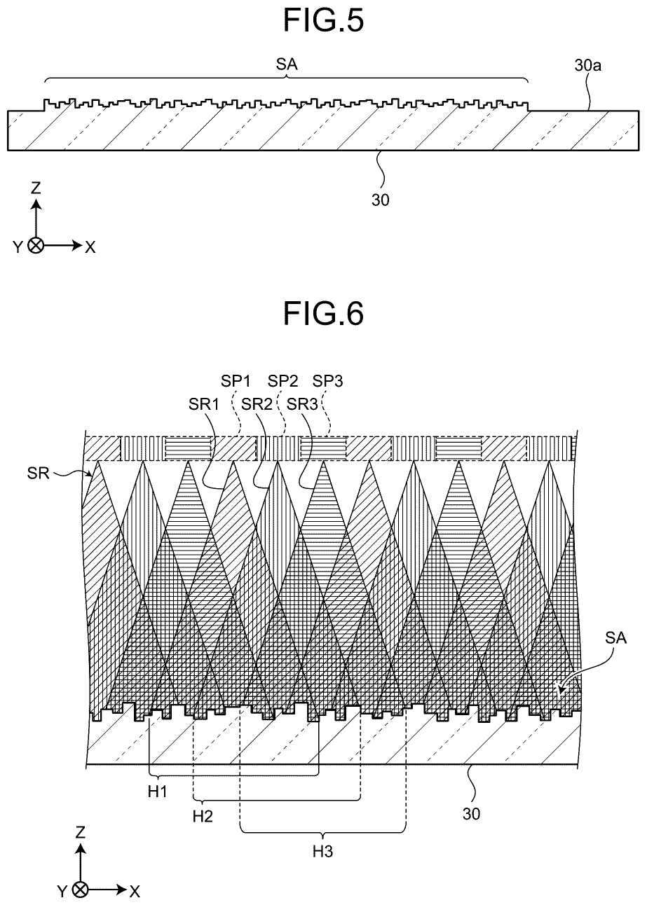

FIG. 5 is a sectional view of the color separation element 30. FIG. 6 is an enlarged sectional view of the color separation element 30. The color separation element 30 disperses the emitted light from the light source device 20 and emits, to the pixel P of the display panel 10, a plurality of rays of separated light SR with wavelengths different from each other. The color separation element 30 has a separation region SA that emits the separated light SR. The separation region SA is on the board surface of the color separation element 30 (front surface of the color separation element 30; hereinafter may be described as an emitting surface 30a) facing the display panel 10 and overlaps the display region DA in plan view.

As illustrated in FIG. 6, the separated light SR emitted from the separation region SA includes first separated light SR1 in red, the same color as the color of the first sub-pixel SP1, second separated light SR2 in green, the same color as the second sub-pixel SP2, and third separated light SR3 in blue, the same color as the third sub-pixel SP3. In the separation region SA, the front surface of the color separation element 30 has a given uneven shape.

The given uneven shape is such that the first separated light SR1 gathers in the first sub-pixel SP1 from a first range H1, which is larger than the first sub-pixel SP1 in plan view and overlaps the first sub-pixel SP1 in plan view. The given uneven shape is such that the second separated light SR2 gathers in the second sub-pixel SP2 from a second range H2, which is larger than the second sub-pixel SP2 in plan view and overlaps the second sub-pixel SP2 in plan view. Furthermore, the given uneven shape is such that the third separated light SR3 gathers in the third sub-pixel SP3 from a third range H3, which is larger than the third sub-pixel SP3 in plan view and overlaps the third sub-pixel SP3 in plan view.

There are a plurality of the first ranges H1 corresponding to the first sub-pixels SP1. There are a plurality of the second ranges H2 corresponding to the second sub-pixels SP2. There are a plurality of the third ranges H3 corresponding to the third sub-pixels SP3. The first range H1, the second range H2, and the third range H3 have portions overlapping each other in plan view.

In this manner, the color separation element 30 separates the emitted light from the light source device 20 for each wavelength corresponding to the color of the individual color filter CF, and causes the light (separated light SR) with the wavelength corresponding to the color filter CF to enter and be transmitted through the color filter CF. Thus, the loss of quantity of the emitted light from the light source device 20 can be suppressed and the utilization efficiency of the emitted light can be increased compared to a case in which the display device 1 does not include the color separation element 30 and the emitted light from the light source device 20 directly enters the display panel 10.

As illustrated in FIG. 2, the adhesive portion 40 bonds the display panel 10 to the color separation element 30. Specifically, the adhesive portion 40 bonds the peripheral portion of the opposite surface 10b of the display panel 10 to the emitting surface 30a of the color separation element 30.

The adhesive portion 40 is formed as an adhesive cures. The adhesive is a one-part adhesive and, for example, an ultraviolet (UV) curable adhesive. The adhesive may be a two-part adhesive or a thermosetting adhesive.

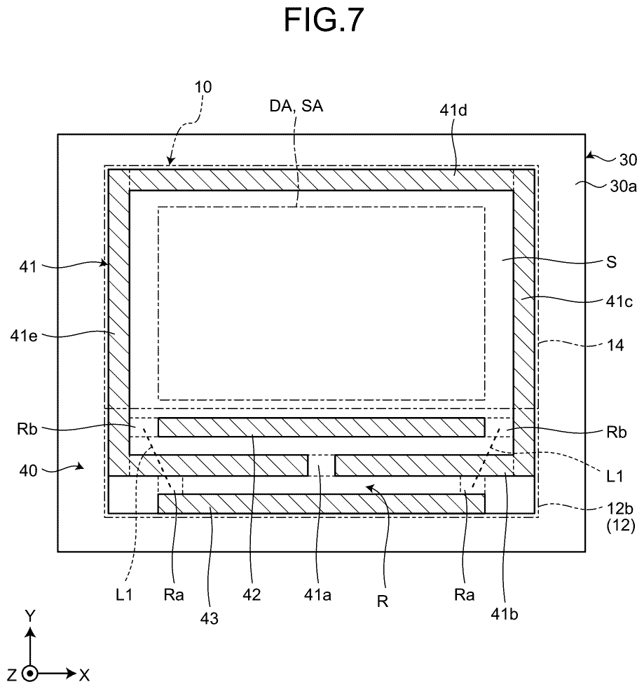

FIG. 7 is a plan view of the display device 1 illustrating the adhesive portion 40 viewed from the display panel 10 side. In FIG. 7, the display panel 10 is illustrated by the dashed and double-dotted line.

The adhesive portion 40 includes a first side wall 41, a second side wall 42, and a third side wall 43. When the first side wall 41, the second side wall 42, and the third side wall 43 are described without distinction, they may simply be described as “side walls”. That is, the adhesive portion 40 includes a plurality of side walls. The side walls couple the display panel 10 to the color separation element 30 and demarcate the space between the display panel 10 and the color separation element 30.

The first side wall 41 surrounds the separation region SA (and the display region DA) in plan view. The first side wall 41 has a communicating portion 41a through which the inside of the first side wall 41 communicates with the outside of the first side wall 41 in plan view. The first side wall 41 is rectangular in plan view. Specifically, the first side wall 41 integrally has, in plan view, a first edge portion 41b on the −Y side of the separation region SA (and the display region DA), a second edge portion 41c on the +X side of the separation region SA, a third edge portion 41d on the +Y side of the separation region SA, and a fourth edge portion 41e on the −X side of the separation region SA. The first edge portion 41b and the third edge portion 41d extend along the X direction. The communicating portion 41a is in the central portion of the first edge portion 41b in the X direction.

The second side wall 42 is inside the first side wall 41 in plan view. Specifically, the second side wall 42 is straight and parallel to the first edge portion 41b, and is present between the separation region SA (and the display region DA) and the first edge portion 41b in plan view. There is a gap between one end portion of the second side wall 42 and the second edge portion 41c, and a gap between the other end portion of the second side wall 42 and the fourth edge portion 41e.

The third side wall 43 is outside the first side wall 41 in plan view. Specifically, the third side wall 43 is straight and parallel to the first edge portion 41b, and is on the opposite side of the second side wall 42 across the communicating portion 41a in plan view. The communicating portion 41a overlaps both the second side wall 42 and the third side wall 43 in side view of the adhesive portion 40 viewed along the Y direction.

The adhesive portion 40 forms a space portion S and a communicating passage R.

The space portion S is an air layer between the display panel 10 and the color separation element 30, the air layer overlapping the display region DA (and the separation region SA) in plan view (see FIGS. 2 and 7). The space portion S is the space between the display panel 10 and the color separation element 30, the space surrounded, in plan view, by the second edge portion 41c, the third edge portion 41d, and the fourth edge portion 41e of the first side wall 41, and the second side wall 42. The distance in the Z direction of the space portion S is the distance in which the separated light SR gathers in the sub-pixel SP.

The communicating passage R is a passage that couples the space portion S to the atmosphere and through which gas can circulate. That is, the communicating passage R couples the space portion S to the outside of the display device 1. The space portion S communicates with the atmosphere through the communicating passage R, thereby preventing condensation from occurring in the space portion S.

The communicating passage R is formed by the outer surfaces of the side walls, the opposite surface 10b of the display panel 10, and the emitting surface 30a of the color separation element 30. Specifically, the communicating passage R is formed, between the opposite surface 10b and the emitting surface 30a, by the space between the third side wall 43 and the first edge portion 41b, the communicating portion 41a, between the first edge portion 41b and the second side wall 42, between the second side wall 42 and the second edge portion 41c, and between the second side wall 42 and the fourth edge portion 41e.

The communicating passage R has a first opening Ra that opens toward the atmosphere and a second opening Rb that opens toward the space portion S, and couples the first opening Ra to the second opening Rb through the communicating portion 41a. In the present embodiment, there are two first openings Ra, corresponding to the space between each of the two end portions of the third side wall 43 and the first edge portion 41b. There are two second openings Rb, corresponding to the space between the second side wall 42 and the second edge portion 41c, and between the second side wall 42 and the fourth edge portion 41e.

Furthermore, the communicating passage R has a labyrinth structure. Specifically, two straight first virtual lines L1 each connecting the first opening Ra to the second opening Rb intersect the first edge portion 41b of the first side wall 41 in plan view, to implement the labyrinth structure. That is, the communicating passage R has such a labyrinth structure that the communicating passage R is bent by the intersection of the first virtual lines L1 and the first edge portion 41b of the first side wall 41. The width of the communicating passage R is 50 μm to 3000 μm. It is needless to say that the width of the communicating passage R is not limited to this size.

Furthermore, the communicating passage R having the aforementioned labyrinth structure is longer than that in a case in which the communicating passage R linearly couples the first opening Ra to the second opening Rb. Thus, the communicating passage R having the aforementioned labyrinth structure suppresses foreign matter reaching the space portion S, the foreign matter having entered the communicating passage R through the first opening Ra from the outside of the display device 1. Consequently, a decrease in luminance of the display region DA resulting from foreign matter's entry into the space portion S can be suppressed.

A section in the first side wall 41 on the −Y side from the second side wall 42, the second side wall 42, and the third side wall 43 overlap the exposed portion 12b of the first substrate 12 in plan view. That is, the communicating passage R overlaps the exposed portion 12b. Thus, the communicating passage R can be formed without enlarging the display device 1.

An application step of applying the adhesive, a sticking step of sticking the display panel 10 and the color separation element 30 together, and a curing step of curing the adhesive in a process for manufacturing the display device 1 will be described next. The application step, the sticking step, and the curing step are performed in this order.

At the application step, the adhesive is applied to one of the opposite surface 10b of the display panel 10 and the emitting surface 30a of the color separation element 30. The adhesive is applied in the same pattern as the placement pattern of the adhesive portion 40 illustrated in FIG. 7. The adhesive is applied using a dispenser. At the sticking step, the color separation element 30 and the display panel 10 are stuck together with the adhesive therebetween. At the sticking step, the emitting surface 30a of the color separation element 30 and the opposite surface 10b of the display panel 10 face each other, and as the display panel 10 and the color separation element 30 approach each other, the opposite surface 10b and the emitting surface 30a come into contact with each other with the adhesive therebetween.

Furthermore, the adhesive is deformed as the display panel 10 approaches the color separation element 30. At this time, air in a section corresponding to the space portion S between the display panel 10 and the color separation element 30 leaks externally through a section corresponding to the communicating passage R formed by the adhesive. Thus, deformation of the color separation element 30 and the display panel 10 due to the force created by air compression between the color separation element 30 and the display panel 10 can be prevented. The distance between the opposite surface 10b and the emitting surface 30a is adjusted to a given distance specified in advance.

The adhesive is cured at the curing step. As described above, the adhesive is a UV curable adhesive, and the adhesive cures as the adhesive is irradiated with ultraviolet light. As the adhesive cures, the adhesive portion 40 is formed.

Although preferred embodiments of the present disclosure have been described above, the present disclosure is not limited to such embodiments. What is disclosed in the embodiments is merely an example, and various modifications can be made without departing from the intent of the present disclosure. Any appropriate modification made to the extent not departing from the intent of the present disclosure naturally belongs to the technical scope of the present disclosure.

The display device 1 according to a first modification of the embodiment described above will be described next mainly with respect to parts that differ from those of the embodiment described above.

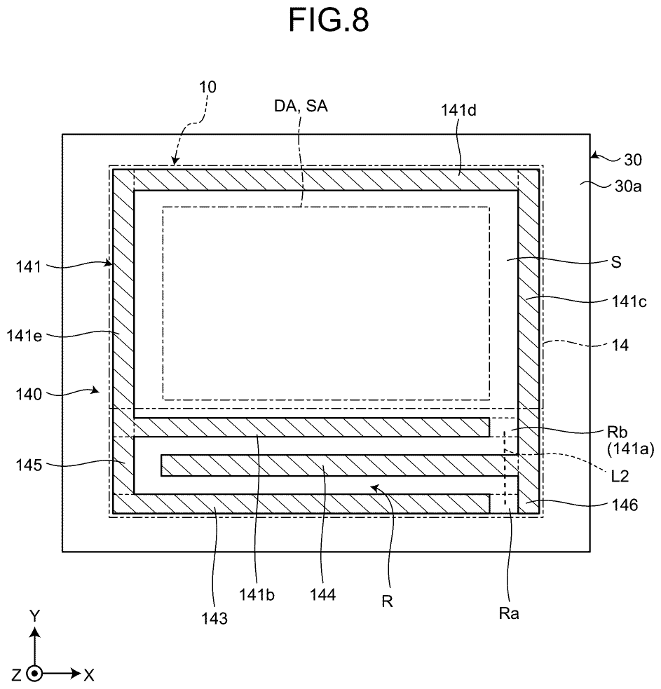

FIG. 8 is a view illustrating an adhesive portion 140 of the display device 1 according to the first modification of the embodiment of the present disclosure. The adhesive portion 140 of this first modification does not include the second side wall 42 of the embodiment described above.

A communicating portion 141a of a first side wall 141 of this first modification is at the end portion on the +X side of a first edge portion 141b. The communicating portion 141a of this first modification corresponds to the second opening Rb.

The adhesive portion 140 of this first modification has a fourth side wall 144, a first coupling wall 145, and a second coupling wall 146. The fourth side wall 144 is present between a third side wall 143 and the first edge portion 141b and is placed parallel to the first edge portion 141b.

The first coupling wall 145 couples a fourth edge portion 141e to the third side wall 143. Specifically, the first coupling wall 145 extends from the fourth edge portion 141e to the −Y side along the Y direction, and is coupled to the end portion on the −X side of the third side wall 143. The first coupling wall 145 and the fourth side wall 144 are separated from each other.

The second coupling wall 146 couples the fourth side wall 144 to a second edge portion 141c. Specifically, the second coupling wall 146 extends from the second edge portion 141c to the −Y side along the Y direction and is coupled to the end portion on the −X side of the fourth side wall 144 at the central portion in the Y direction. The second coupling wall 146 and the third side wall 143 are separated from each other. The space between the second coupling wall 146 and the third side wall 143 corresponds to the first opening Ra.

In this first modification, there is one first opening Ra and one second opening Rb. A second virtual line L2 coupling the first opening Ra to the second opening Rb intersects the fourth side wall 144. As a result, the communicating passage R of this first modification has a labyrinth structure in which the communicating passage R is bent by the coupling of the first opening Ra and the second opening Rb through the space between the first coupling wall 145 and the fourth side wall 144.

The display device 1 according to a second modification of the embodiment described above will be described next mainly with respect to parts that differ from those of the first modification (see FIG. 8) of the embodiment described above.

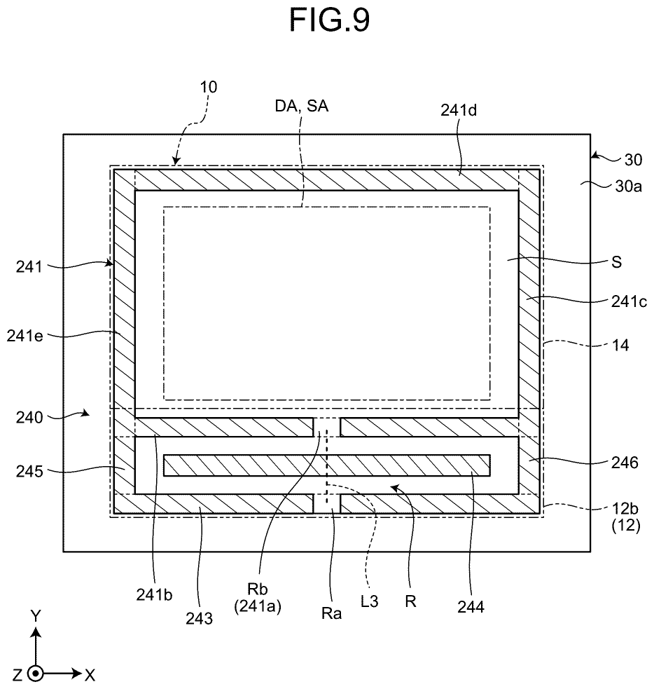

FIG. 9 is a view illustrating an adhesive portion 240 of the display device 1 according to the second modification of the embodiment of the present disclosure.

In the adhesive portion 240 of this second modification, a communicating portion 241a is in the central portion of a first edge portion 241b in the X direction, and corresponds to the second opening Rb as in the first modification described above. A second coupling wall 246 is coupled to the end portion on the +X side of a third side wall 243. The third side wall 243 has the first opening Ra in the central portion in the X direction. Furthermore, a fourth side wall 244 is separated from the second coupling wall 246.

In this second modification, a third virtual line L3 coupling the first opening Ra to the second opening Rb intersects the fourth side wall 244. As a result, the communicating passage R of this second modification has a labyrinth structure in which the communicating passage R is bent by the coupling of the first opening Ra and the second opening Rb through the space between a first coupling wall 245 and the fourth side wall 244 and the space between the second coupling wall 246 and the fourth side wall 244.

The display device 1 of a third modification of the embodiment described above will be described next mainly with respect to parts that differ from those of the first modification (see FIG. 8) of the embodiment described above.

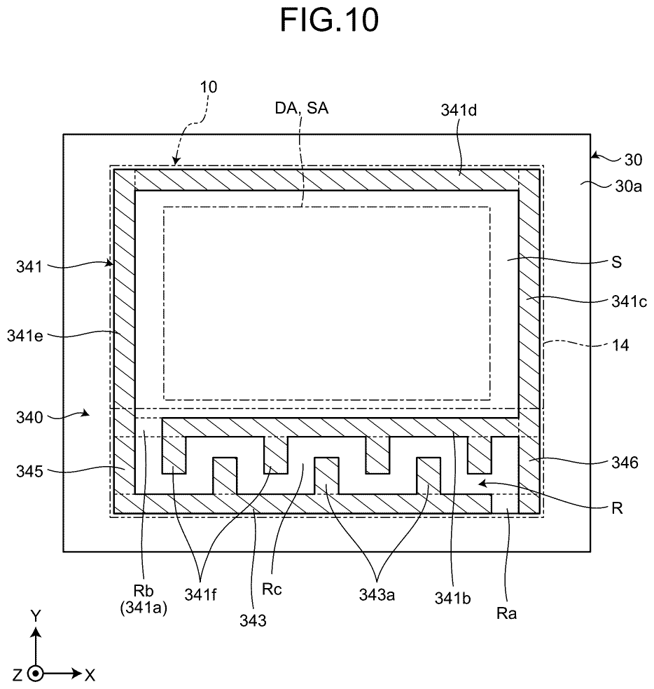

FIG. 10 is a view illustrating an adhesive portion 340 of the display device 1 according to the third modification of the embodiment of the present disclosure. In this third modification, the adhesive portion 340 does not include the fourth side wall 144 of the first modification described above.

In the adhesive portion 340 of this third modification, a communicating portion 341a is at the end portion on the −X side of a first edge portion 341b, and corresponds to the second opening Rb. The adhesive portion 340 has a plurality of first protruding walls 341f extending from the first edge portion 341b to the −Y side along the Y direction. The first protruding walls 341f are aligned along the X direction.

Furthermore, the adhesive portion 340 has a plurality of second protruding walls 343a extending from a third side wall 343 to the +Y side along the Y direction. The second protruding walls 343a are aligned along the X direction. The first protruding walls 341f and the second protruding walls 343a are alternately aligned in the X direction, and tip portions of the first protruding walls 341f and tip portions of the second protruding walls 343a overlap in side view of the display device 1 viewed along the X direction.

As a result, the section between the first opening Ra and the second opening Rb is continuously bent and meanders in the communicating passage R. In other words, the communicating passage R has a meandering portion Rc winding its way through. The communicating passage R has the meandering portion Rc that implements a labyrinth structure.

The display device 1 according to a fourth modification of the embodiment described above will be described next mainly with respect to parts that differ from those of the third modification (see FIG. 10) of the embodiment described above.

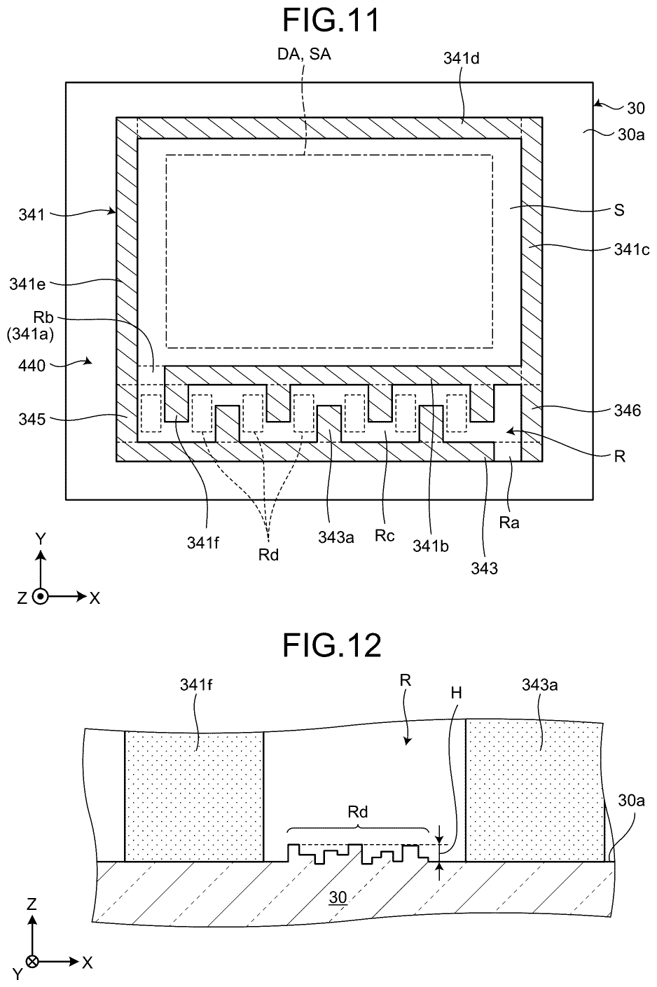

FIG. 11 is a view illustrating an adhesive portion 440 of the display device 1 according to the fourth modification of the embodiment of the present disclosure. In the adhesive portion 440 of this fourth modification, the section in the emitting surface 30a of the color separation element 30 that forms the communicating passage R has a first uneven region Rd having irregularities. The first uneven region Rd is present between the first protruding wall 341f and the second protruding wall 343a. A plurality of the first uneven regions Rd are formed.

FIG. 12 is a partially enlarged sectional view of the communicating passage R illustrating the first uneven region Rd. The uneven shape of the first uneven region Rd is the same as the given uneven shape formed in the separation region SA. Thus, the uneven shape of the first uneven region Rd can be formed at a timing at which the given uneven shape of the separation region SA is formed. It is needless to say that the uneven shape of the first uneven region Rd is not limited to the given uneven shape, and may be formed by a plurality of grooves parallel to each other and a plurality of grooves intersecting each other.

A height H of the uneven shape of the first uneven region Rd is greater than 0 and equal to or less than 1/200 of the distance in the Z direction of the communicating passage R (distance between the emitting surface 30a and the opposite surface 10b). It is needless to say that the height H of the uneven shape of the first uneven region Rd is not limited to the aforementioned height.

Foreign matter that has entered the communicating passage R through the first opening Ra from the outside of the display device 1 is caught in the first uneven region Rd. Thus, the communicating passage R can further suppress the foreign matter reaching the space portion S.

The display device 1 of a fifth modification of the embodiment described above will be described next mainly with respect to parts that differ from those of the first modification (see FIG. 8) of the embodiment described above.

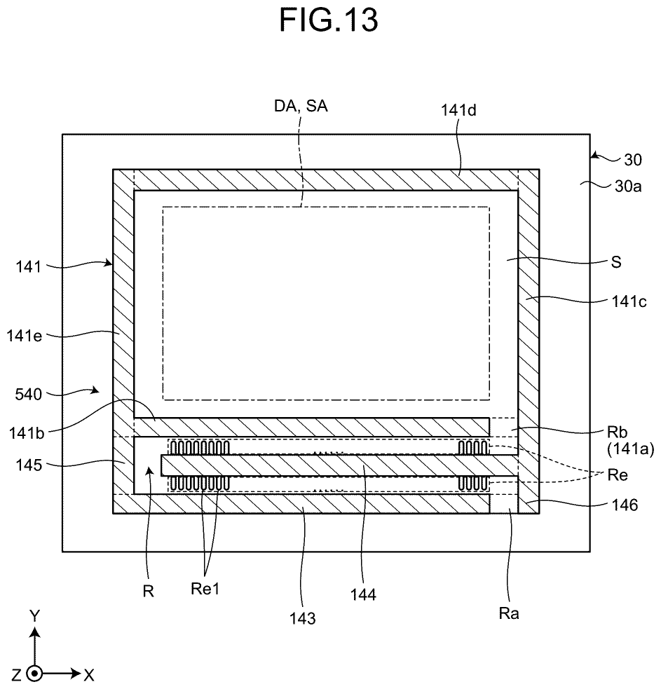

FIG. 13 is a view illustrating an adhesive portion 540 of the display device 1 according to the fifth modification of the embodiment of the present disclosure. In the adhesive portion 540 of this fifth modification, the section in the emitting surface 30a of the color separation element 30 that forms the communicating passage R has a second uneven region Re having irregularities. The second uneven region Re has a plurality of convex portions Re1 extending from the fourth side wall 144 along the section in the emitting surface 30a of the color separation element 30 that forms the communicating passage R. The second uneven region Re is formed one on each side of the fourth side wall 144 in the Y direction.

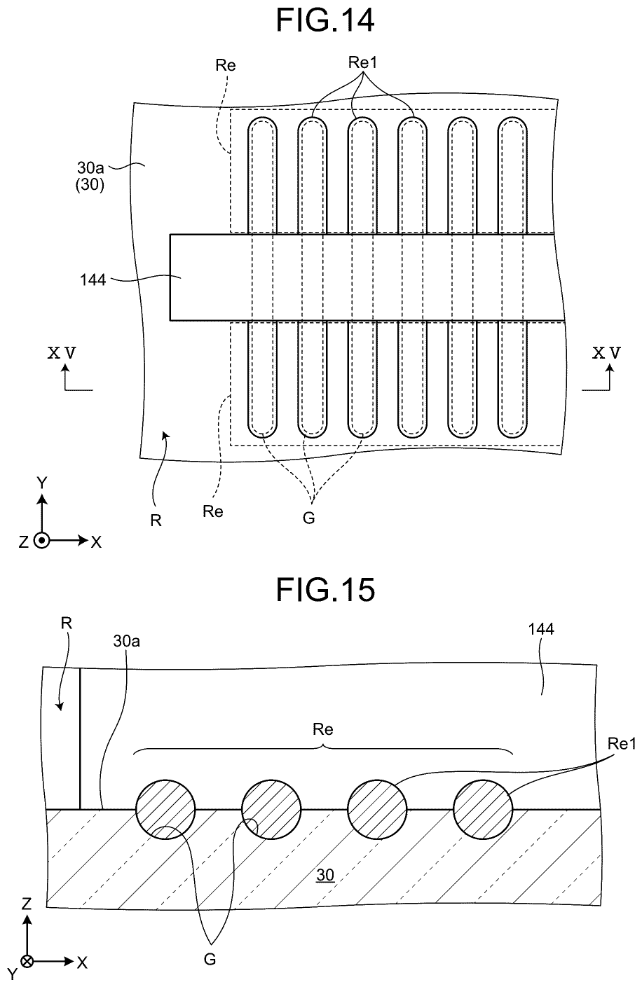

FIG. 14 is an enlarged plan view of the communicating passage R illustrating the second uneven regions Re. FIG. 15 is a sectional view of the display device 1 taken along a line XV-XV illustrated in FIG. 14. The emitting surface 30a has the grooves G formed therein. The grooves G each extend along the Y direction in plan view and overlap the fourth side wall 144 in the central portion of the Y direction. The convex portions Re1 overlap the grooves G on both sides of the fourth side wall 144 in the Y direction in plan view. The convex portions Re1 are formed as the adhesive cures, similarly to the adhesive portion 540.

Specifically, the adhesive is applied to the emitting surface 30a at the aforementioned application step. When the adhesive is applied to the position corresponding to the fourth side wall 144, the adhesive flows along the grooves G by capillary and stays in a raised state from the emitting surface 30a. Furthermore, when the adhesive cures at the aforementioned curing step, the second uneven regions Re are formed by the formation of a plurality of side walls and the convex portions Re1.

Foreign matter that has entered the communicating passage R through the first opening Ra from the outside of the display device 1 is caught in the second uneven regions Re. Thus, the communicating passage R can further suppress the foreign matter reaching the space portion S. The grooves G may be formed at a section on the emitting surface 30a that overlaps in plan view one of the first edge portion 141b, the first coupling wall 145, and the second coupling wall 146. In this case, the convex portions Re1 extend from one of the first edge portion 141b, the first coupling wall 145, and the second coupling wall 146. Instead of the grooves G, the aforementioned given uneven shape may be formed at a section corresponding to the second uneven region Re. In this case, the adhesive flows along the given uneven shape at the application step.

It is understood that any other effects brought about by the modes described in the embodiments that are obvious from the description of the present specification or that would be conceived of by a person skilled in the art are naturally brought about by the present disclosure.

Here, the first side wall 41, the second side wall 42, the third side wall 43, the fourth side wall 144, the first coupling wall 145, and the second coupling wall 146 correspond to a “side wall”, respectively. Further, the first virtual line L1, the second virtual line L2, and the third virtual line L3 correspond to a “virtual line”, respectively. Further, the first uneven region Rd and the second uneven region Re correspond to an “uneven region”, respectively.

What is claimed is:

1. A display device comprising:
a display panel having a display surface having a display region where an image is displayed and an opposite surface on an opposite side of the display surface;
a color separation element placed on the opposite surface side of the display panel and configured to disperse light from a light source and to emit, to the display panel, a plurality of rays of separated light with wavelengths different from each other; and
an adhesive portion bonding the display panel to the color separation element, wherein
the adhesive portion forms a space portion overlapping the display region in plan view of the display surface and also has a plurality of side walls forming a communicating passage through which the space portion communicates with an atmosphere, and
the communicating passage has a labyrinth structure.

2. The display device according to claim 1, wherein
the communicating passage has:
a first opening that opens toward an atmosphere; and
a second opening that opens toward the space portion, and
one of the side walls intersects a straight virtual line connecting the first opening to the second opening in plan view of the display surface, to implement the labyrinth structure.

3. The display device according to claim 1, wherein the communicating passage has a meandering portion that implements the labyrinth structure.

4. The display device according to claim 1, wherein
the communicating passage is formed by outer surfaces of the side walls, the opposite surface of the display panel, and an emitting surface from which the color separation element emits the separated light, and
a section in the emitting surface forming the communicating passage has an uneven region having irregularities.

5. The display device according to claim 4, wherein the uneven region has a plurality of convex portions extending from the side wall along the section in the emitting surface forming the communicating passage.

6. The display device according to claim 1, wherein
the display panel comprises:
a first substrate; and
a second substrate facing the first substrate across a liquid crystal layer,
the first substrate has an exposed portion sticking out from the second substrate in plan view of the display surface, and
the communicating passage overlaps the exposed portion in plan view of the display surface.
